(19) United States
(12) Patent Application Publication
(10) Pub. No.: US 2021/0025969 A1
(43) Pub. Date: Jan. 28, 2021

(54) RADAR DEVICE

(71) Applicant: HITACHI AUTOMOTIVE SYSTEMS, LTD., Hitachinaka-shi, Ibaraki (JP)

(72) Inventors: Katsumi OUCHI, Hitachinaka-shi (JP); Akira KITAYAMA, Hitachinaka-shi (JP)

(73) Assignee: HITACHI AUTOMOTIVE SYSTEMS, LTD., Hitachinaka-shi, Ibaraki (JP)

(21) Appl. No.: 16/969,022

(22) PCT Filed: Jan. 29, 2019
(86) PCT No.: PCT/JP2019/002847

§ 371 Date: Aug. 11, 2020

(30) Foreign Application Priority Data
Mar. 6, 2018 (JP) 2018-039407

(51) Int. Cl. G01S 7/35; G01S 13/42; G01S 7/03

(52) U.S. Cl. CPC G01S 7/352; G01S 7/03; G01S 13/42

(57) ABSTRACT

A radar device includes a plurality of antenna elements aligned in a left-right direction and an up-down direction. A CPU that calculates the individual arrival angles in an arrival angle group for the left-right direction on the basis of reflected waves received by the plurality of antenna elements aligned in the left-right direction and the individual arrival angles in an arrival angle group for the up-down direction on the basis of reflected waves received by the plurality of antenna elements aligned in the up-down direction. According to the combination of the number of left-right direction arrival angles and up-down direction arrival angles, the CPU selects a method for pairing the arrival angles for the left-right direction and the up-down direction. The radar device is capable of appropriately pairing arrival angles in the two sets of directions and specifying the two-dimensional directions of each of a plurality of objects.

### TECHNICAL FIELD

The present invention relates to a radar device.

### BACKGROUND ART

Conventionally, there is known a radar device which is mounted on a vehicle to detect an object such as an obstacle in the surroundings, for use in an automatic driving and a driving support system of a vehicle. In general, the above radar device modulates a radio wave in a frequency band excellent in linearity such as a millimeter waveband (77 GHz, 79 GHz) or quasi-millimeter waveband (24 GHz) by using a modulation method such as frequency modulated continuous wave (FMCW) modulation or multi-frequency CW modulation, and radiates the radio wave. Then, a reflected wave of the radiated radio wave from a peripheral object is received and treated with signal processing, and relative distance, speed, direction (angle) of the peripheral object to the radar device are calculated.

A multiple signal classification (MUSIC) method is known as a direction-of-arrival estimation method that realizes high angular resolution. The MUSIC method enables arrival angle estimation with high resolution by scanning null points of a directional pattern. The distance and the relative velocity are measured from a frequency peak of the received signal by the fast Fourier transform (FFT), and the angle of the object is estimated by the MUSIC method from FFT peak information.

### CITATION LIST

### Patent Literature

PTL 1: JP 6028388 B2

### SUMMARY OF INVENTION

### Technical Problem

In order to realize high angular resolution not only in a left-right direction but also in an up-down direction and reduce an amount of calculation, a case is considered in which the one-dimensional MUSIC method is applied to the left-right direction and the up-down direction, respectively.

At this time, if there are a plurality of arrival angles obtained by the MUSIC method in the left-right direction and a plurality of arrival angles obtained in the MUSIC method in the up-down direction, respectively, for a plurality of objects that are at the same distance and at the same speed, it is difficult to identify two-dimensional directions of the objects.

For example, if the number of objects such as vehicles is two, and there are two arrival angles for each direction, that is, the arrival angles in the left-right direction are θ_{H1} and θ_{H2}, and the arrival angles in the up-down direction are θ_{V1} and θ_{V2}, there are two possibilities in the two-dimensional directions of the objects, (left-right angle: up-down angle)=(θ_{H1}:θ_{V1}) (θ_{H2}:θ_{V2}) or (θ_{H1}:θ_{V2}) (θ_{H2}:θ_{V1}).

Similarly, if the number of objects is three and the numbers of incoming waves in the left-right and up-down directions are all three, there are 6 possibilities in the two-dimensional directions of the objects, and if the number of objects is four and the numbers of incoming waves in the left-right direction and up-down direction are all four, there are 24 possibilities in the two-dimensional directions of the objects, which makes it more difficult to identify the two-dimensional direction of each object.

An object of the present invention is to provide a radar device that can appropriately pair an arrival angle in a first direction with an arrival angle in a second direction to identify a two-dimensional direction of each of a plurality of objects.

### Solution to Problem

In order to achieve the above object, the present invention includes a plurality of antenna elements arranged in a first direction, a plurality of antenna elements arranged in a second direction different from the first direction, and a processor. The processor calculates individual arrival angles of an arrival angle group in the first direction based on reflected waves received by the plurality of antenna elements arranged in the first direction, calculates individual arrival angles of an arrival angle group in the second direction based on reflected waves received by the plurality of antenna elements arranged in the second direction, and according to a combination of a number of the arrival angles in the first direction and a number of the arrival angles in the second direction, selects a method of pairing the individual arrival angles of the arrival angle group in the first direction with the individual arrival angles of the arrival angle group in the second direction.

### Advantageous Effects of Invention

According to the present invention, it is possible to appropriately pair the arrival angle in the first direction with the arrival angle in the second direction, and identify the two-dimensional direction of each of the plurality of objects. Problems, configurations, and effects other than those described above will become apparent from the following description of the embodiment.

### BRIEF DESCRIPTION OF DRAWINGS

FIG. 1 is a diagram showing a configuration of a radar device according to an embodiment of the present invention.

FIG. 2 is a diagram showing an arrangement of antenna elements according to the embodiment of the present invention.

FIG. 3 is a diagram showing an operation flow of the radar device according to the embodiment of the present invention.

FIG. 4 is a diagram showing a flow of signal processing according to the embodiment of the present invention.

FIG. 5 is a diagram showing a flow of pairing method selection according to the embodiment of the present invention.

FIG. 6 is a diagram showing a flow of one-to-one pairing processing according to the embodiment of the present invention.

FIG. 7 shows a pairing management table according to the embodiment of the present invention.

FIG. 8 is a diagram showing a result of the one-to-one pairing processing according to the embodiment of the present invention.

FIG. 9 is a diagram showing a flow of one-to-many pairing processing according to the embodiment of the present invention.

FIG. 10 is a diagram showing a result of the one-to-many pairing processing according to the embodiment of the present invention.

FIG. 11 is a diagram showing a flow of the one-to-one and one-to-many pairing processing according to the embodiment of the present invention.

FIG. 12 is a diagram showing a result of the one-to-one and one-to-many pairing processing according to the embodiment of the present invention.

### DESCRIPTION OF EMBODIMENT

Hereinafter, a configuration and an operation of a radar device according to an embodiment of the present invention are described with reference to the drawings.

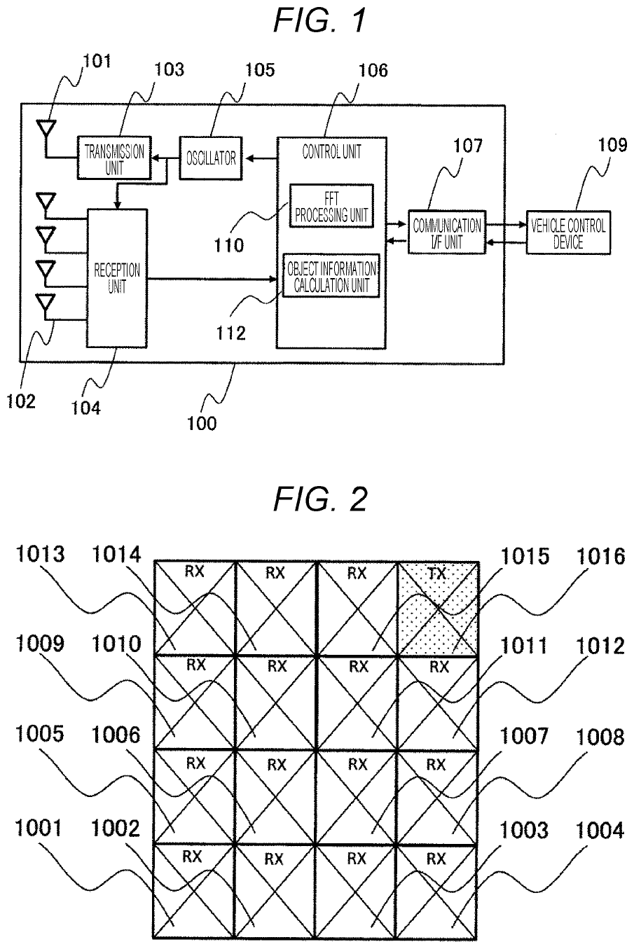

FIG. 1 is a diagram showing a configuration of a radar device 100 according to one embodiment of the present invention. The radar device 100 is mounted on a vehicle such as an automobile and used to detect an object in the surroundings of the vehicle, and includes a transmitting antenna 100, a receiving antenna 102, a transmitting unit 103, a receiving unit 104, an oscillator 105, a control unit 106, and a communication interface (I/F) unit 107. The radar device 100 is connected to a vehicle control device 109 provided inside the vehicle.

The oscillator 105 generates a frequency-modulated modulation signal and supplies the signal to the transmitting unit 103 and the receiving unit 104. In the oscillator 105, for example, a phase locked loop (PLL) is used which is configured by including a voltage controlled oscillator (VCO), a multiplier, and the like. A frequency of the modulation signal output from the oscillator 105 or a frequency obtained by dividing the frequency of the modulation signal by a predetermined ratio is controlled (modulated) by the control unit 106.

When an object in the surroundings of the vehicle is detected, the transmitting unit 103 outputs a frequency-modulated transmitting signal to the transmitting antenna 101 by power-amplifying the modulation signal from the oscillator 105. This transmitting signal is radiated via the transmitting antenna 101 as a radio wave toward the surroundings of the vehicle, for example, the front of the vehicle. Hereinafter, a period of time during which the frequency-modulated transmitting signal is radiated from the transmitting antenna 101 is referred to as a “modulation operation period”.

When the object in the surroundings of the vehicle is detected, the receiving unit 104 receives a signal obtained after the transmitting signal emitted from the transmitting unit 103 via the transmitting antenna 101 during the modulation operation period is reflected by the object in the surroundings of the vehicle and is input to the receiving antenna 102. Hereinafter, the signal thus received by the receiving unit 104 according to the transmitting signal from the transmitting unit 103 is referred to as a “received signal”.

Then, the received signal is mixed with the modulation signal from the oscillator 105 to generate a beat signal according to a frequency difference between the above two signals, and frequency down conversion is performed. The beat signal generated in the receiving unit 104 is input to the control unit 106 after unnecessary frequencies are cut through a not-shown band limiting filter.

When the object in the surroundings of the vehicle is detected, the control unit 106 causes the oscillator 105 to generate a modulation signal for the transmitting unit 103 to radiate a transmitting signal during the modulation operation period. Then, after digital data obtained by analog-to-digital (A/D) converting the beat signal from the receiving unit 104 is input, the control unit 106 performs signal processing for detecting the object in the surroundings of the vehicle based on the digital data. Hereinafter, a period of time during which the control unit 106 performs the above signal processing is referred to as a “signal processing period”.

The control unit 106 includes, as its functions, an FFT processing unit 110 and an object information calculation unit 112. The control unit 106 is configured by using, for example, a central processing unit (CPU), a read only memory (ROM), a random access memory (RAM), and the like, and realizes the functions by executing a program stored in the ROM by the CPU. Each of the functions of the control unit 106 may be realized by hardware such as a field programmable gate array (FPGA).

The digital data of the beat signal output from the receiving unit 104 and A/D converted is input to the FFT processing unit 110. The FFT processing unit 110 performs the FFT on the basis of the digital data of the input beat signal to obtain a signal waveform in which the beat signal is decomposed into frequency components. Information of the signal waveform obtained by the FFT processing unit 110, that is, spectrum information of the received signal is output to the object information calculation unit 112.

The object information calculation unit 112 detects the object in the surroundings of the vehicle based on the spectrum information of the received signal output from the FFT processing unit 110, and calculates object information. Specifically, the object information calculation unit 112 calculates the object information representing relative distance, speed, angle, and the like of the object with respect to the radar device 100 by identifying a frequency of a signal representing the object in the surroundings of the vehicle from the spectrum information of the received signal, and performing angle estimation processing, tracking processing, and the like. The object information calculated by the object information calculation unit 112 is transmitted to the vehicle control device 109 through the communication I/F unit 107.

In the radar device 100, a set of the modulation operation period and the signal processing period (hereinafter referred to as a “frame”) is repeated at regular intervals. The modulation operation period and the signal processing period may be separate periods that do not overlap with each other in the same frame, or some or all of the periods may overlap with each other.

The communication I/F unit 107 performs interface processing of communication signals input and output between the radar device 100 and the vehicle control device 109. With this interface processing performed by the communication I/F unit 107, a signal processing result of the control unit 106 is transmitted to the vehicle control device 109, and various control data transmitted from the vehicle control device 109 is also input to the control unit 106.

Note that the configuration of the radar device 100 described with reference to FIG. 1 is merely an example.

The content of the present invention is not limited to these configurations, and is applicable to radar devices in general having other configurations. For example, a plurality of transmitting antennas 101 may be provided, and the FFT processing unit 110 may be realized by hardware different from the control unit 106.

Next, with reference to FIG. 2, the description is made of an example of an arrangement of antenna elements which constitute the transmitting antenna 101 and the receiving antenna 102, respectively, in the radar device 100 according to the embodiment of the present invention.

In the present embodiment, an example is described in which the transmitting antenna 101 and the receiving antenna 102 are each constituted of a plurality of antenna elements using horn antennas.

FIG. 2 is a diagram showing the arrangement of the antenna elements in the transmitting antenna 101 and the receiving antenna 102 according to the embodiment of the present invention.

In FIG. 2, the receiving antenna 102 in which the antenna elements 1001 to 1015 are arranged and the transmitting antenna 101 in which the antenna element 1016 is arranged are viewed from a side of the transmitting and receiving surface (the front of the radar).

As shown in FIG. 2, the plurality of antenna elements (1001 to 1004) and the like are arranged in the left-right direction (first direction). Further, the plurality of antenna elements (1001, 1005, 1009, 1013) and the like are arranged in the up-down direction (second direction) different from the left-right direction (first direction). The up-down direction may be referred to as the first direction and the left-right direction as the second direction.

Although not shown, the antenna elements 1001 to 1016 each include a horn part, a patch antenna formed on a dielectric substrate, and a dielectric lens.

The antenna elements 1001 to 1015 are receiving antenna elements. The antenna elements 1001 to 1015 receive millimeter waves reflected from an object such as a vehicle.

The antenna element 1016 is a transmitting antenna element. The antenna element 1016 transmits a millimeter wave to the front of the vehicle.

In the present embodiment, the control unit 106 uses groups of received signals of the antenna elements (1001 to 1004), (1005 to 1008), and (1009 to 1012) as different snapshots, and uses the MUSIC method to detect angles in the left-right direction of the plurality of objects.

Similarly, the control unit 106 uses groups of received signals of the antenna elements (1001, 1005, 1009, 1013), (1002, 1006, 1010, 1014), and (1003, 1007, 1011, 1015) as different snapshots, and uses the MUSIC method to detect angles in the up-down direction of the plurality of objects.

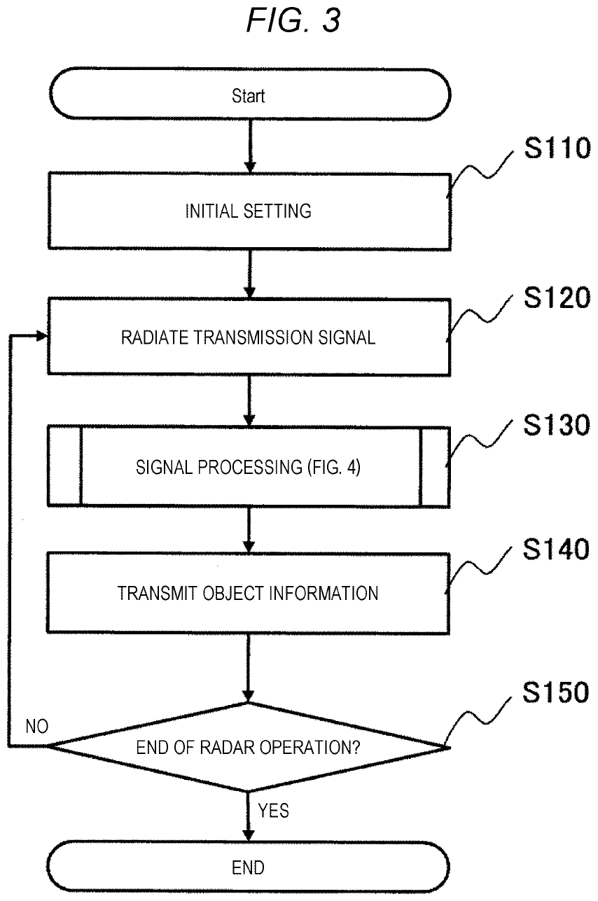

Next, details of processing performed by the control unit 106 in the present embodiment are described. FIG. 3 is a diagram showing an operation flow of the radar device 100 according to the one embodiment of the present invention.

The control unit 106 realizes the processing shown in the flowchart of FIG. 3 by a program executed by the CPU, for example.

In step S110, the control unit 106 initializes various parameters in the radar device 100. Here, initial values are set, the values including a modulation setting parameter for the modulation signal generated by the oscillator 105 during the modulation operation period, and a signal processing setting parameter for the signal processing performed by the control unit 106 during the signal processing period. As the initial values of these parameters, those stored in advance in the radar device 100 may be used, or the values used immediately before may be used.

In step S120, the control unit 106 controls the oscillator 105 and the transmitting unit 103 to radiate a frequency-modulated transmitting signal from the transmitting antenna 101 toward the surroundings of the vehicle. At this time, the control unit 106 controls the frequency of the modulation signal generated by the oscillator 105 by using the modulation setting parameter initialized in step S110, and determines the frequency band of the transmitting signal.

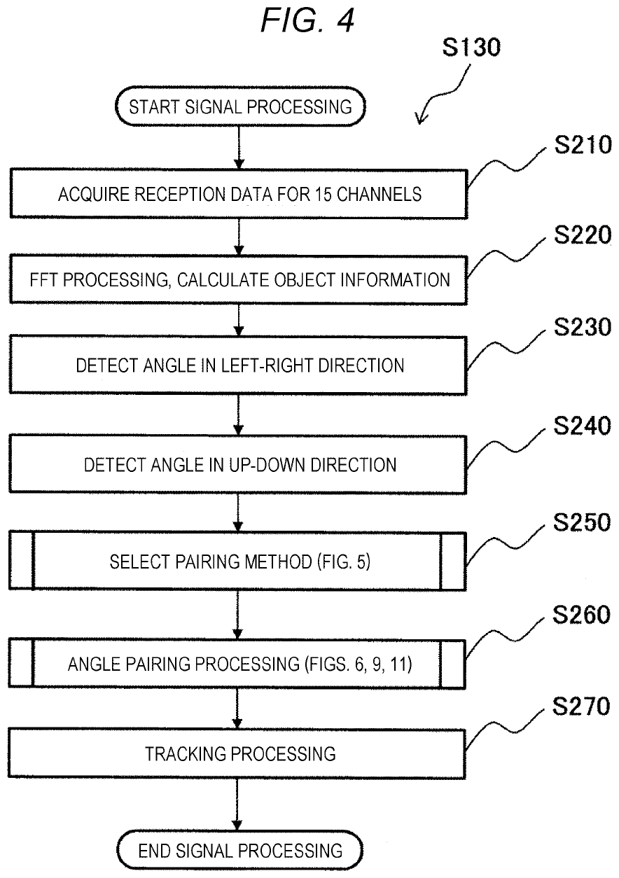

In step S130, the control unit 106 uses digital data of a beat signal output from the receiving unit 104 according to a received signal which is the transmitting signal radiated in step S120 and reflected by an object in the surroundings of the vehicle, and performs signal processing to detect the object. Here, by performing signal processing according to a flowchart of FIG. 4 described later, the object in the surroundings of the vehicle is detected from the received signal, and relative distance, speed, angle, and the like of the object are calculated as object information.

In step S140, the control unit 106 transmits the object information calculated in step S130 to the vehicle control device 109 via the communication I/F unit 107.

In step S150, the control unit 106 determines whether or not a preset operation end condition of the radar device 100 is satisfied. If the operation end condition of the radar device 100 is not satisfied, the control unit 106 returns to step S120 and repeats the above processing. On the other hand, if the operation end condition of the radar device 100 is satisfied, the control unit 106 ends the processing shown in the flowchart of FIG. 3 and is stopped.

Next, details of the signal processing performed by the control unit 106 in step S130 of FIG. 3 in the present embodiment are described. FIG. 4 is a diagram showing a flow of the signal processing according to the embodiment of the present invention. In the present embodiment, the control unit 106 performs the signal processing of step S130 according to the flowchart of FIG. 4.

In step S210, the control unit 106 acquires received signals for 15 channels output from the receiving antenna 102, that is, received data of the receiving channel. Here, digital data of individual beat signals of the receiving channel output from the receiving unit 104 is acquired as received data for 15 channels corresponding to the receiving channel.

In step S220, the control unit 106 first performs the FFT processing on the received data for 15 channels acquired in step S210 in the FFT processing unit 110, thereby frequency spectrum information of the receiving channel is individually acquired.

Subsequently, in the object information calculation unit 112, by using the signal processing setting parameters initialized in step S110, the object in the surroundings of the vehicle is detected from the frequency spectrum information of the receiving channel, and the relative distance and speed of the object are calculated as the object information.

In step S230, the control unit 106 performs angle detection in the left-right direction from FFT peak information. Here, the angle detection is performed by the Root-MUSIC method that calculates an arrival angle by numerical calculation.

An input vector of an array antenna is represented by X, and a correlation matrix Rₓₓ is represented by a formula (1).

[Mathematical formula 1]

Rₓₓ [symbol] E[X(t)X^{H}(t)] (1)

Here, E[] indicates an ensemble average, and X^{H} indicates a conjugate transposed matrix of X.

In a uniform linear array, a mode vector a(θ) forming a directional matrix A expressed by a formula (2) below is expressed by a formula (3). The mode vector a(θ) indicates an amplitude ratio/phase difference of each antenna element with respect to a direction of θ.

[Mathematical formula 2]

A=[α(θ₁), . . . , α(θ_{L})] (2)

Here, L is the number of incoming waves.

$$\begin{matrix}[ Mathematical formula 3 ] & \\ \begin{matrix}a ( θ ) & = [ 1 , exp ( - j \frac{2 π}{λ} d sin θ ) , exp ( - j \frac{2 π}{λ} 2 d sin θ ) , … , \\ & { exp ( - j \frac{2 π}{λ} ( K - 1 ) d sin θ ) ]}^{T} \\ & = {[ 1 , z , {z}^{2} , … , {z}^{( K - 1 )} ]}^{T} \\ & ≡ p ( z ) \\ & z {=}^{△} exp ( - j \frac{2 π}{λ} d sin θ )\end{matrix} \} & ( 3 )\end{matrix}$$

Here, when a Root-MUSIC polynomial Q(z) is defined by a formula (4), the solution of Q (z)=0 and L double roots on a unit circle (|z|=1) are represented by a formula (5).

$$\begin{matrix}[ Mathematical formula 4 ] & \\ Q ( z ) = {z}^{K - 1} {p}^{T} ( {z}^{- 1} ) {E}_{N} {E}_{N}^{H} p ( z ) = {z}^{K - 1} {\sum }_{i = L + 1}^{K} {S}_{i} ( z ) {S}_{i}^{*} ( 1 \text{/} {z}^{*} ) & ( 4 ) \\ [ Mathematical formula 5 ] & \\ {z}_{l} = exp ( - j \frac{2 π}{λ} d sin {θ}_{l} ) ( l = 1 , 2 , … , L ) & ( 5 )\end{matrix}$$

From the formula (5), a direction of arrival θk (k=1, 2, . . . , K) is obtained. Once the direction of arrival is obtained, a signal correlation matrix S represented by a formula (6) is calculated. From the i-th diagonal component of the matrix S, receiving power (intensity) of the i-th incoming wave can be obtained.

[Mathematical formula 6]

S=(A^{H}A)⁻¹A^{H}(Rₓₓ−σ²I)A(A^{H}A)⁻¹ (6)

Here, A^{H} is the conjugate transposed matrix of A, σ² is a variance of noise vector, and I is a unit matrix.

In this way, the CPU (processor) of the control unit 106 calculates individual arrival angles (direction of arrival ek) of an arrival angle group in the left-right direction based on the reflected waves received by the plurality of antenna elements (1001 to 1004, etc.) arranged in the left-right direction (first direction).

In step S240, the control unit 106 performs the angle detection in the up-down direction from the FFT peak information. Also here, the angle detection is performed by the Root-MUSIC method similar to step S230. That is, the CPU (processor) of the control unit 106 calculates individual arrival angles of an arrival angle group in the up-down direction based on the reflected waves received by the plurality of antenna elements (1001, 1005, 1009, 1013, etc.) arranged in the up-down direction (second direction).

In step S250, the control unit 106 selects a pairing method for the angles individually detected in steps S230 and S240.

Hereinafter, details of pairing method selection performed by the control unit 106 in step S250 of FIG. 4 in the present embodiment are described.

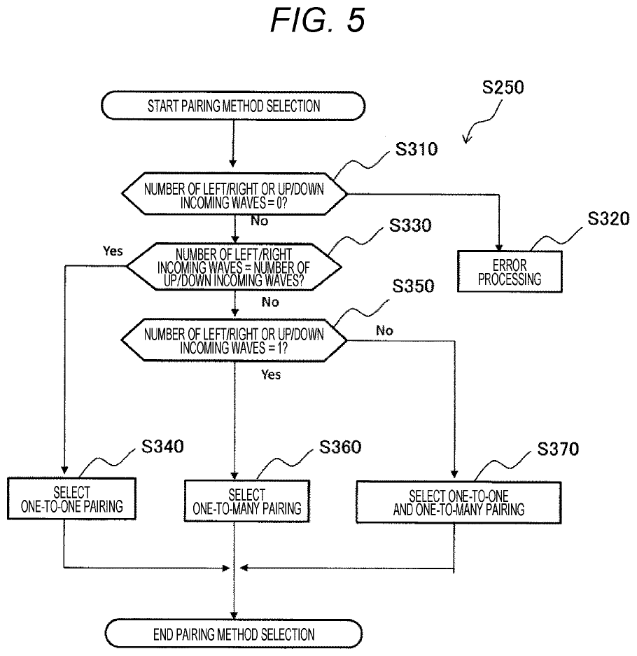

FIG. 5 is a diagram showing a flow of the pairing method selection according to the embodiment of the present invention. In the present embodiment, the control unit 106 performs the pairing method selection of step S250 according to the flowchart of FIG. 5.

In step S310, the control unit 106 determines whether or not either the number of incoming waves in the left-right direction detected in step S230 or the number of incoming waves in the up-down direction detected in step S240 is equal to zero.

If either the number of incoming waves in the left-right direction or the number of incoming waves in the up-down direction is equal to zero, the control unit 106 performs non-detection processing (error processing) in step S320. At this time, the control unit 106 ends the signal processing of step S130 of FIG. 3, omits the object information transmission processing of step S140, and proceeds to step S150. That is, the CPU (processor) of the control unit 106 does not identify the direction of the object (detection target), if the number of arrival angles in the left-right direction (first direction) or the number of arrival angles in the up-down direction (second direction) is zero.

On the other hand, if both the number of incoming waves in the left-right direction and the number of incoming waves in the up-down direction are one or more, the control unit 106 proceeds to step S330. That is, when the number of arrival angles in the left-right direction (first direction) and the number of arrival angles in the up-down direction (second direction) is one or more, the CPU (processor) of the control unit 106 identifies the direction of the object (detection target) by the arrival angle in the left-right direction and the arrival angle in the up-down direction which are paired, as described below.

In step S330, the control unit 106 determines whether or not the number of incoming waves in the left-right direction is equal to the number of incoming waves in the up-down direction.

If the number of incoming waves in the left-right direction is equal to the number of incoming waves in the up-down direction, the control unit 106 selects the one-to-one pairing processing as the pairing method in step S340, and ends the processing shown in the flowchart of FIG. 5.

On the other hand, if the number of incoming waves in the left-right direction is different from the number of incoming waves in the up-down direction, the control unit 106 proceeds to step S350.

In step S350, the control unit 106 determines whether or not either the number of incoming waves in the left-right direction or the number of incoming waves in the up-down direction is equal to one.

If either the number of incoming waves in the left-right direction or the number of incoming waves in the up-down direction is equal to one, the control unit 106 selects the one-to-many pairing processing as the pairing method in step S360, and ends the processing shown in the flowchart of FIG. 5.

On the other hand, if both the number of incoming waves in the left-right direction and the number of incoming waves in the up-down direction are two or more, the control unit 106 selects one-to-one and one-to-many pairing processing as the pairing method in step S370, and ends the processing shown in the flowchart of FIG. 5.

In other words, the CPU (processor) of the control unit 106 selects the method of pairing the individual arrival angles of the arrival angle group in the left-right direction and the individual arrival angles of the arrival angle group in the up-down direction, according to the combination of the number of arrival angles in the left-right direction (first direction) and the number of arrival angles in the up-down direction (second direction). Thereby, the arrival angle in the left-right direction (first direction) and the arrival angle in the up-down direction (second direction) can be appropriately paired (matched).

Returning to FIG. 4, in step S260, the control unit 106 performs angle pairing processing that uses the pairing method selected in step S250 for the angle in the left-right direction and the angle in the up-down direction detected in steps S230 and S240, respectively.

Hereinafter, details of the angle pairing processing performed by the control unit 106 in step S260 of FIG. 4 in the present embodiment are described.

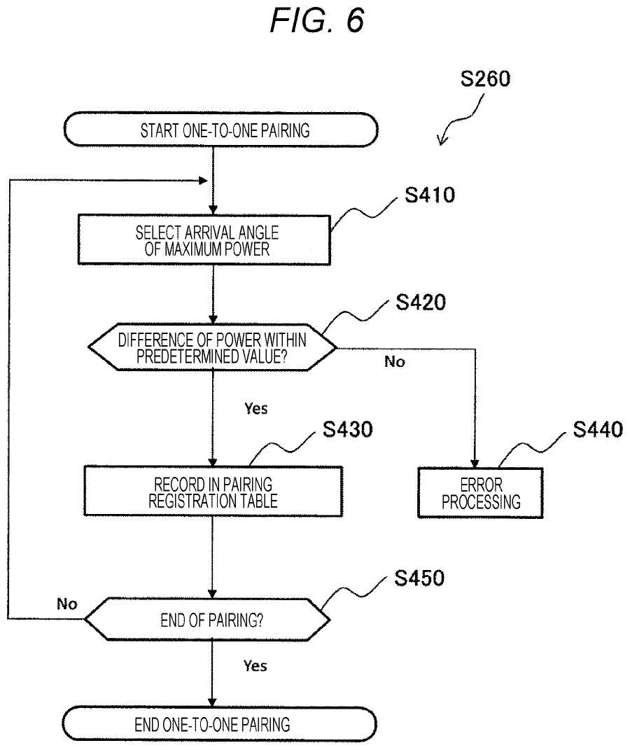

FIG. 6 is a diagram showing a flow of the one-to-one pairing processing according to the embodiment of the present invention.

In the present embodiment, if the one-to-one pairing processing is selected in step S250, the control unit 106 performs the angle pairing processing of step S260 according to the flowchart of FIG. 6.

In step S410, the control unit 106 selects the arrival angles at each of which an incoming wave power value is the maximum, from the arrival angle groups detected in the left-right and up-down directions, respectively. Note that, in the present embodiment, as an example, the arrival angle at which the incoming wave power value is the maximum is selected first. However, as described below, the processing from step S410 to step S450 is repeated for all the arrival angles, and accordingly, for example, the arrival angle at which the incoming wave power value is the minimum may be selected first.

In step S420, the control unit 106 determines whether or not a difference between the incoming wave power values corresponding to the pair of arrival angles selected in step S410 is within a predetermined value. Note that there is a characteristic that the power value of the incoming wave in the left-right direction and the power value of the incoming wave in the up-down direction are substantially the same for one object. As a result, if the difference between the power values of the incoming waves corresponding to the pair of arrival angles selected in step S410 is within the predetermined value, it means that the pair of arrival angles selected in step S410 corresponds to the incoming waves from one object.

When the difference between the incoming wave power values is within the predetermined value, the control unit 106 proceeds to step S430. On the other hand, if the difference between the incoming wave power values exceeds the predetermined value, the control unit 106 performs non-detection processing (error processing) in step S440.

In step S430, the control unit 106 records the pair of arrival angles selected in step S410 in a pairing management table 400. In other words, for example, if the number of arrival angles in the left-right direction (first direction) is equal to the number of arrival angles in the up-down direction (second direction) (Yes in S330 in FIG. 5), the CPU (processor) of the control unit 106 pairs the arrival angle in the left-right direction with the arrival angle in the up-down direction such that the difference between the absolute value of the power of the incoming waves in the left-right direction and the absolute value of the power of the incoming waves in the up-down direction is within the predetermined value. As a result, the arrival angle in the left-right direction and the arrival angle in the up-down direction from one object can be appropriately paired.

In step S450, the control unit 106 determines whether or not all of the arrival angles have been selected.

If all of the arrival angles have not been selected, the control unit 106 returns to step S410 and repeats the above processing. On the other hand, if all of the arrival angles have been selected, the one-to-one pairing processing flow is ended.

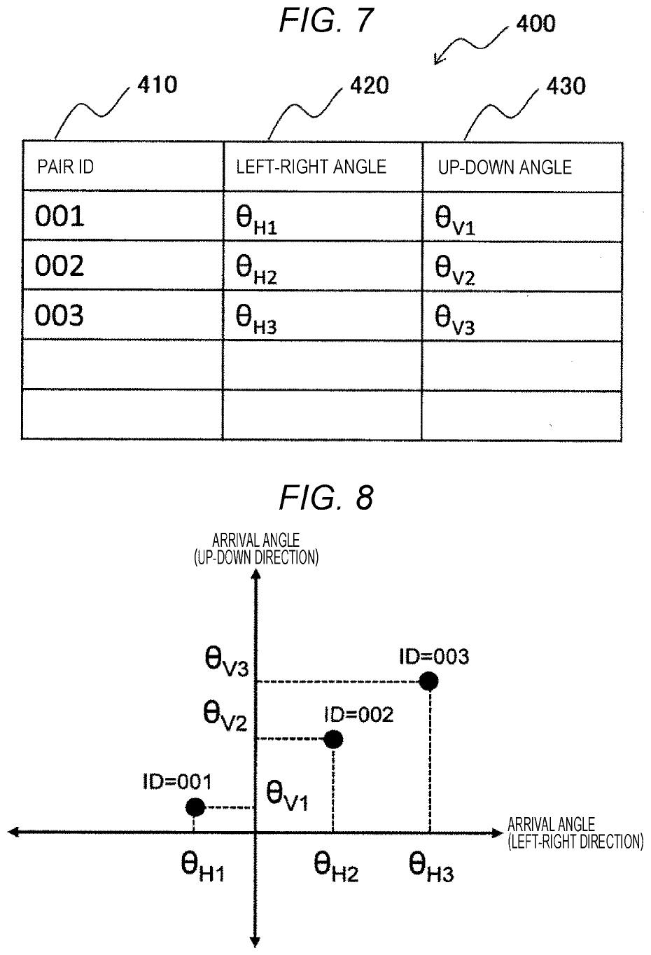

FIG. 7 shows an example of the pairing management table 400. The pairing management table 400 is stored in the memory in the control unit 106.

Each row of the pairing management table 400 stores information about a pair of arrival angles. A column 410 registers a pair ID as a unique number in the pairing management table 400. A column 420 stores the arrival angle in the left-right direction among the paired arrival angles. The column 430 stores the arrival angle in the up-down direction among the paired arrival angles.

In the example of FIG. 7, as a result of the one-to-one pairing processing, the left-right angle _{eH1} and the up-down angle θ_{V1} are paired as the pair ID=001, the left-right angle θ_{H2} and the up-down angle θ_{V2} are paired as the pair ID=002, and the left-right angle θ_{H3} and the up-down angle θ_{V3} are paired as the pair ID=003, and the result is registered in the pairing management table 400.

FIG. 8 shows an example in which the result of the one-to-one pairing processing according to the embodiment of the present invention is plotted on the two-dimensional coordinates.

The horizontal axis represents the arrival angle in the left-right direction, and the vertical axis represents the arrival angle in the up-down direction. The intersection of the horizontal axis and the vertical axis is 0 degrees in both the left-right direction and the up-down direction, which corresponds to the front direction when viewed from the radar device. FIG. 8 corresponds to the contents of the pairing management table 400 shown in FIG. 7.

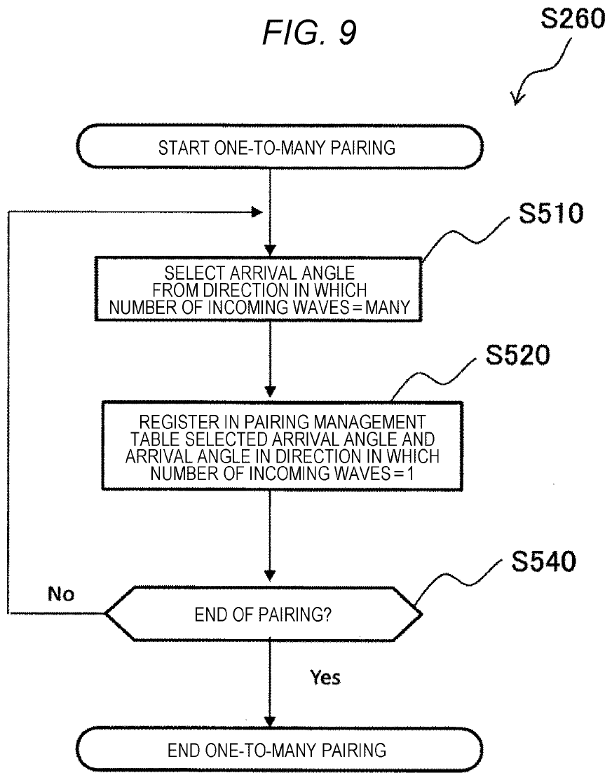

FIG. 9 is a diagram showing a flow of the one-to-many pairing processing according to the embodiment of the present invention.

In the present embodiment, if the one-to-many pairing processing is selected in step S250, the control unit 106 performs the angle pairing processing of step S260 according to the flowchart of FIG. 9.

In step S510, the control unit 106 selects one arrival angle from the direction in which the number of incoming waves is two or more, among the left-right direction or the up-down direction.

In step S520, the control unit 106 records in the pairing management table 400 the one arrival angle selected in step S510 and the arrival angle in the direction in which the number of incoming waves is one. In other words, if the number of arrival angles in the up-down direction (second direction) is one, and the number of arrival angles in the left-right direction (first direction) is two or more, the CPU (processor) of the control unit 106 pairs the arrival angle in the up-down direction with the individual arrival angles of the arrival angle group in the left-right direction. Because the power of the incoming waves in each of the left-right direction and the up-down direction is not calculated, the calculation load can be reduced as compared with the one-to-one pairing processing.

In step S540, the control unit 106 determines whether or not all of the arrival angles have been selected.

If the selection of all of the arrival angles has not been completed, the control unit 106 returns to step S510 and repeats the above processing. On the other hand, if the selection of all the arrival angles has been completed, the control unit 106 ends the processing shown in the flowchart of FIG. 9.

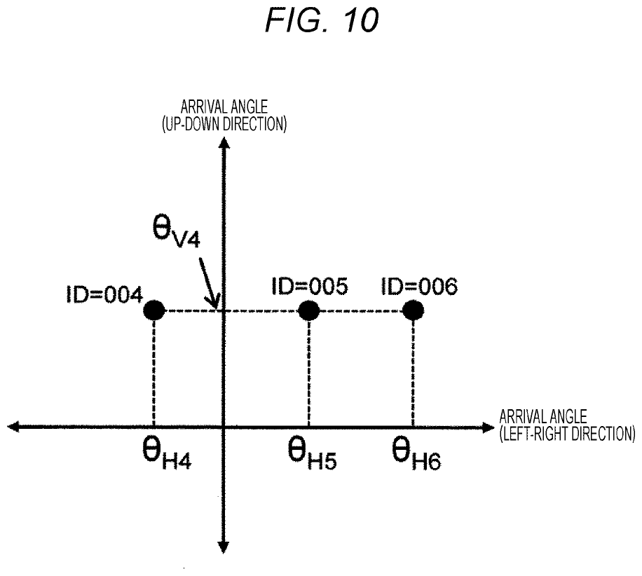

FIG. 10 shows an example in which the result of the one-to-many pairing processing according to the embodiment of the present invention is plotted on the two-dimensional coordinates.

In the example of FIG. 10, the number of incoming waves in the left-right direction is three, and the number of incoming waves in the up-down direction is one. Here, it is considered that the incoming waves received by the receiving antenna in the up-down direction are incoming waves from three objects.

As the result of the one-to-many pairing processing, the left-right angle θ_{H4} and the up-down angle θ_{V4} are paired as the pair ID=004, the left-right angle θ_{H5} and the up-down angle θ_{V4} are paired as the pair ID=005, and the left-right angle θ_{H6} and the up-down angle θ_{V4} are paired as the pair ID=006, and the directions of the three objects are identified.

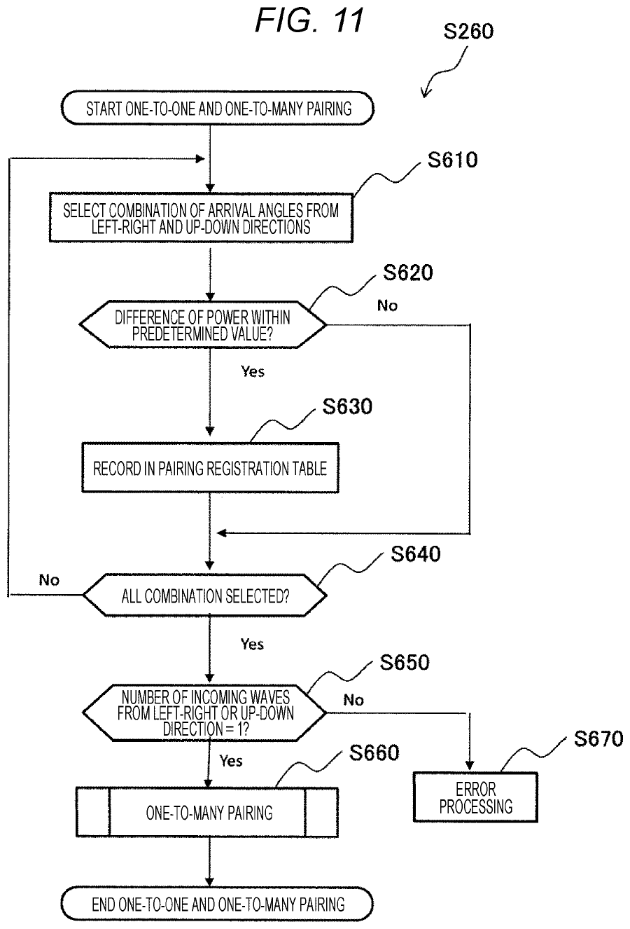

FIG. 11 is a diagram showing a flow of the one-to-one and one-to-many pairing processing according to the embodiment of the present invention.

In the present embodiment, if the one-to-one or one-to-many pairing processing is selected in step S250, the control unit 106 performs the angle pairing processing of step S260 according to the flowchart of FIG. 11.

In step S610, the control unit 106 selects one arrival angle from each combination of arrival angles respectively detected in the left-right and up-down directions.

In step S620, the control unit 106 determines whether or not a difference between the incoming wave power values corresponding to the pair of arrival angles selected in step S610 is within a predetermined value.

If the difference between the incoming wave power values is within the predetermined value, the control unit 106 proceeds to step S630. On the other hand, if the difference between the incoming wave power values exceeds the predetermined value, the control unit 106 proceeds to step S640.

In step S630, the control unit 106 records the pair of arrival angles selected in step S610 in the pairing management table 400. In other words, for example, if the number of arrival angles in the up-down direction (second direction) is two or more, and the number of arrival angles in the left-right direction (first direction) is larger than the number of arrival angles in the up-down direction, the CPU (processor) of the control unit 106 pairs the arrival angle in the left-right direction with the arrival angle in the up-down direction by the one-to-one pairing such that the difference between the absolute value of the power of the incoming waves in the left-right direction and the absolute value of the power of the incoming waves in the up-down direction is within the predetermined value. As a result, the arrival angle in the left-right direction and the arrival angle in the up-down direction from one object can be appropriately paired.

In step S640, the control unit 106 determines whether or not all of the combinations of arrival angles have been selected.

If the selection of all of the combinations of arrival angles has not been completed, the control unit 106 returns to step S610 and repeats the above processing. On the other hand, if the selection of all of the combinations of arrival angles has been completed, the control unit 106 proceeds to step S650.

In step S650, the control unit 106 determines whether or not the number of incoming waves in either the left-right direction or the up-down direction is equal to one, excluding the number of incoming waves in the left-right direction and the number of incoming waves in the up-down direction which have already been paired in step 630.

When the number of incoming waves in either the left-right direction or the up-down direction is equal to one, the control unit 106 performs the one-to-many pairing processing in step S660. The one-to-many pairing processing is the same as in FIG. 9. That is, for example, if the number of arrival angles in the up-down direction (second direction) that has not been paired is one, the CPU (processor) of the control unit 106 pairs the arrival angle in the up-down direction with the individual arrival angles of the arrival angle group in the left-right direction (first direction) that have not been paired with the arrival angle in the up-down direction. The processing performs the one-to-many pairing processing in the case of Yes in step S650 after exiting a loop between step S610 and step S640. Accordingly, the individual arrival angles of the arrival angle group in the left-right direction and the individual arrival angles of the arrival angle group in the up-down direction can be appropriately paired while the calculation load is reduced.

On the other hand, if the number of incoming waves in the left-right direction and the number of incoming waves in the up-down direction are both two or more, the control unit 106 performs non-detection processing (error processing) in step 5670.

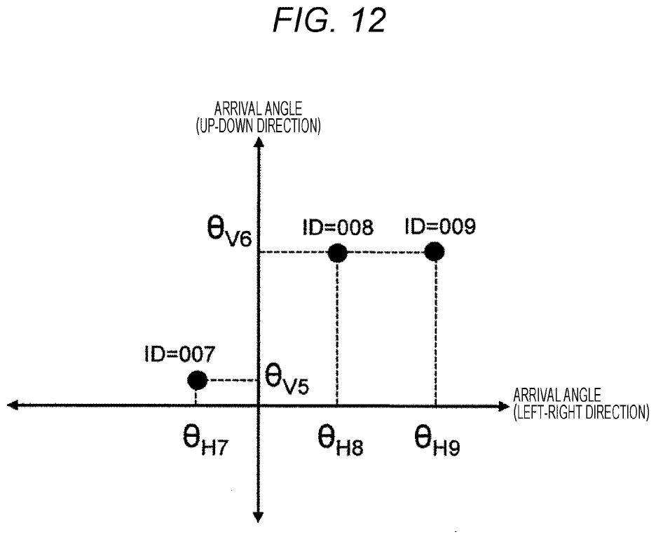

FIG. 12 shows an example in which the result of the one-to-one and one-to-many pairing according to the embodiment of the present invention are plotted on the two-dimensional coordinates.

In the example of FIG. 12, the number of incoming waves in the left-right direction is three, and the number of incoming waves in the up-down direction is two. Here, it is considered that in the incoming waves received by the receiving antenna in the up-down direction, incoming waves from two objects are combined.

As the result of the one-to-one and one-to-many pairing processing, the left-right angle θ_{H7} and the up-down angle θ_{V5} are paired as the pair ID=007, the left-right angle θ_{H8} and the up-down angle θ_{V6} are paired as the pair ID=008, and the left-right angles θ_{H9} and θ_{V6} are paired as the pair ID=009, and the two-dimensional directions of the three objects are identified.

Returning to FIG. 4, in step S270, the control unit 106 performs tracking processing of the object based on the histories of the object information calculated in steps S220 and S250, respectively.

After step S270 is performed, the control unit 106 ends the signal processing shown in FIG. 4.

According to the embodiment of the present invention, with respect to the plurality of objects in front of the radar device 100, the two-dimensional directions can be identified from the angles detected using the MUSIC method in the left-right direction and the MUSIC method in the up-down direction. That is, the arrival angle in the left-right direction (first direction) and the arrival angle in the up-down direction (second direction) can be appropriately paired to identify the two-dimensional direction of each of the plurality of objects.

In the above embodiment, an example has been described in which the transmitting antenna 101 and the receiving antenna 102 are configured by using the plurality of horn antennas as the antenna elements, however, the present invention is not limited to this.

Because the number of incoming waves that can be detected by the MUSIC method is (the number of antennas −1), by setting the number of receiving antennas in the left-right direction to three or more and the number of receiving antennas in the up-down direction to three or more, the plurality of objects can be detected in each direction. Therefore, the effect of the present invention can be obtained.

Furthermore, in the above embodiment, an example has been described in which the MUSIC method is used as the high resolution incoming wave estimation method, however, the present invention is not limited to this. For example, estimation of signal parameters via rotational invariance techniques (ESPRIT) may be used.

The above-described embodiment and various modifications are merely examples, and the present invention is not limited to these contents as long as the features of the present invention are not impaired.

Although various embodiments and modifications have been described above, the present invention is not limited to these contents. Other embodiments that can be considered within the scope of the technical idea of the present invention are also included in the scope of the present invention.

For example, in the above-described embodiment, the plurality of antenna elements are arranged in the left-right direction (first direction) and the up-down direction (second direction), however, the first direction and the second direction may not be orthogonal to each other.

For example, the above-described embodiments have been described in detail in order to explain the present invention in an easy-to-understand manner, and are not necessarily limited to those including all the configurations described.

Moreover, each of the above-described configurations, functions, and the like may be partially or entirely realized by hardware by designing an integrated circuit, or the like. Further, each of the above-described configurations, functions, and the like may be realized by software by a processor (CPU) interpreting and executing a program for realizing each of the functions. Information such as a program, a table, and a file that realizes each function can be placed in a recording device such as a memory, a hard disk, or a solid state drive (SSD), or a recording medium such as an integrated circuit (IC) card, a secure digital (SD) card, ora digital versatile disc (DVD).

In addition, the embodiment of the present invention may be the following aspects.

(1) An object position detection device using electromagnetic waves and having a plurality of antennas, in which: a first arrival angle group is acquired by analyzing electromagnetic waves received by the antennas arranged in a first direction; a second arrival angle group is acquired by analyzing electromagnetic waves received by the antennas arranged in a second direction different from the first direction; a method of associating the first arrival angle group with the second arrival angle group is selected according to a relationship between the number of the first arrival angle group and the number of the second arrival angle group; and directions of one or more objects are individually identified.

(2) The object position detection device according to (1), in which, if the number of arrival angles constituting the first arrival angle group is equal to the number of arrival angles constituting the second arrival angle group, the arrival angles having a difference in absolute values of incoming wave power within a predetermined value are associated with each other.

(3) The object position detection device according to (1), in which, among the number of arrival angles constituting the first arrival angle group and the number of arrival angles constituting the second arrival angle group, if one of the above is two or more and the other is one, the arrival angle groups are associated with each other.

(4) The object position detection device according to (1), in which, if both of the number of arrival angles constituting the first arrival angle group and the number of arrival angles constituting the first arrival angle group are two or more and different from each other, the arrival angles having a difference in absolute values of incoming wave power within the predetermined value are associated with each other, and the remaining arrival angles are associated with each other.

(5) The object position detection device according to (1), in which, if the first arrival angle group or the second arrival angle group cannot be acquired, the direction of the object is not identified.

According to (1) to (5), in the radar device (object position detection device) applying the arrival angle estimation method in each of the first direction and the second direction (the left-right direction and the up-down direction), the two dimensional (left-right direction and up-down direction) directions of the plurality of objects that are at the same distance and at the same speed can be identified.

### REFERENCE SIGNS LIST

100 radar device
101 transmitting antenna
102 receiving antenna
103 transmitting unit
104 receiving unit
105 oscillator
106 control unit
107 communication I/F unit
109 vehicle control device
110 FFT processing unit
112 object information calculation unit

1. A radar device comprising:
a plurality of antenna elements arranged in a first direction;
a plurality of antenna elements arranged in a second direction different from the first direction; and
a processor,
wherein the processor
calculates individual arrival angles of an arrival angle group in the first direction based on reflected waves received by the plurality of antenna elements arranged in the first direction,
calculates individual arrival angles of an arrival angle group in the second direction based on reflected waves received by the plurality of antenna elements arranged in the second direction, and
according to a combination of a number of the arrival angles in the first direction and a number of the arrival angles in the second direction, selects a method of pairing the individual arrival angles of the arrival angle group in the first direction with the individual arrival angles of the arrival angle group in the second direction.

2. The radar device according to claim 1, wherein, if the number of arrival angles in the first direction is equal to the number of arrival angles in the second direction, the processor pairs the arrival angle in the first direction with the arrival angle in the second direction such that a difference between an absolute value of power of incoming waves in the first direction and an absolute value of power of incoming waves in the second direction is within a predetermined value.

3. The radar device according to claim 1, wherein, if the number of arrival angles in the second direction is one and the number of arrival angles in the first direction is two or more, the processor pairs the arrival angle in the second direction with the individual arrival angles of the arrival angle group in the first direction.

4. The radar device according to claim 1, wherein
if the number of arrival angles in the second direction is two or more, and the number of arrival angles in the first direction is larger than the number of arrival angles in the second direction,
the processor
(a) pairs the arrival angle in the first direction with the arrival angle in the second direction such that a difference between an absolute value of power of incoming waves in the first direction and an absolute value of power of incoming waves in the second direction is within a predetermined value, and
(b) if, after (a), the number of arrival angles in the second direction that has not been paired is one, pairs the arrival angle in the second direction with the individual arrival angles of the arrival angle group in the first direction that have not been paired.

5. The radar device according to claim 1, wherein
the processor
identifies a direction of an object by the arrival angle in the first direction and the arrival angle in the second direction that have been paired, if the number of arrival angles in the first direction and the number of arrival angles in the second direction is one or more, and
does not identify the direction of the object if the number of arrival angles in the first direction or the number of arrival angles in the second direction is zero.
